(19) United States
(12) Patent Application Publication
(10) Pub. No.: US 2026/0349632 A1
(43) Pub. Date: Nov. 5, 2026

(54) METHOD FOR INFORMATION PROCESSING APPARATUS, AND INFORMATION PROCESSING APPARATUS

(71) Applicant: CANON KABUSHIKI KAISHA, Tokyo (JP)

(72) Inventor: AKIHIKO TOKUDA, Kanagawa (JP)

(21) Appl. No.: 19/649,967

(22) Filed: Apr. 16, 2026

(30) Foreign Application Priority Data
May 1, 2025 (JP) 2025-076161

(51) Int. Cl. G06F 3/12

(52) U.S. Cl. CPC G06F 3/1226; G06F 3/1205; G06F 3/1253; G06F 3/1285

(57) ABSTRACT

A method for an information processing apparatus includes determining a method for determining a type of a printing apparatus, acquiring, in a case where it is determined to acquire information indicating the type from the printing apparatus, the information indicating the type from the printing apparatus, and in a case where it is determined to cause a user to select the type, a result of selection of the type by the user, and displaying, based on the acquired type, functions having a same function with different names.

### BACKGROUND

### Field of the Technology

The present disclosure relates to a method for an information processing apparatus executed on a host computer or the like, the method being configured to generate print data and to transmit the print data to a printing apparatus connected to the host computer, and to an information processing.

### Description of the Related Art

Software, which is installed on a host computer or the like and configured to create print data and transmit print data to a printing apparatus connected to the host computer, converts data from various applications operating on the host computer into the print data. Software having such a role is generally referred to as a printer driver, and enables designation of various functions that can be executed by the printing apparatus.

The printer driver displays various setting items so that executable functions of a printing apparatus connected via the Internet or the like can be designated, and receives settings from a user. Some printer drivers have a mechanism that switches the functions to be displayed for each connected printing apparatus, and such printer drivers are referred to as a universal printer driver, a generic printer driver, or the like.

The generic printer driver may support a printing apparatus as a transmission destination of print data that performs printing processing using a developer (hereinafter referred to as toner) based on an electrophotographic method or that performs printing processing by application of ink. Hereinafter, a printer based on the former method is referred to as an electrophotographic printer, and a printer based on the latter method is referred to as an inkjet printer.

Some printing apparatuses employ both of the two types of printing processing methods described above. For example, a method for switching between the two types of printing processing methods is described in Japanese Patent Laid-Open No. 08-310047.

In a case where a printer driver has a mode for reducing consumption of a developer such as toner or ink, for example, "toner save mode" can be displayed in the case of the former and "ink save mode" can be displayed in the case of the latter.

However, in a case where the generic printer driver is used, as illustrated in FIGS. 5A and 5B, for the same function, the same text is displayed regardless of a type of a printer to be subjected to printing (electrophotographic method, inkjet method, or the like), and a command for designating the function is issued.

Alternatively, as illustrated in FIG. 6, although an issued command is the same, functions are managed as separate functions. In the case of an electrophotographic printer, a function D 911, a function F 913, and a function I 915 are displayed, and the corresponding commands D, F, and I are issued, respectively. In the case of an inkjet printer, although the corresponding commands are the same as those of the electrophotographic printer, the functions are displayed as separate functions, namely, a function E 912, a function G 914, and a function J 916.

There is a need to improve the operability of a driver that can switch the functions to be displayed for each connected printing apparatus.

### SUMMARY

According to an aspect of the present disclosure, a method for an information processing apparatus includes determining a method for determining a type of a printing apparatus, acquiring, in a case where it is determined to acquire information indicating the type from the printing apparatus, the information indicating the type from the printing apparatus, and in a case where it is determined to cause a user to select the type, a result of selection of the type by the user, and displaying, based on the acquired type, functions having a same purpose with different names.

A determination is made as to which method is used by a printer to be subjected to printing, and a text to be displayed for the same function is switched accordingly.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a system.

FIG. 2 is a diagram illustrating an example of a configuration of a host computer.

FIG. 3 is a diagram illustrating an example of a configuration of a printer driver.

FIG. 4 is a diagram illustrating another example of a configuration of the printer driver.

FIG. 5A illustrates an example of a display of a conventional printer driver, and FIG. 5B illustrates a table representing an example of displayed character strings of the conventional printer driver and issued commands.

FIG. 6 is a table representing another example of displayed character strings and issued commands of a conventional printer driver.

FIG. 7 is a diagram illustrating an example of an operation flow of the printer driver.

FIG. 8 is a diagram illustrating an example of a storage method of character strings to be displayed according to the present disclosure.

FIG. 9 is a diagram illustrating a first example display screen of the printer driver according to the present disclosure.

FIG. 10 is a diagram illustrating a second example display screen of the printer driver according to the present disclosure.

FIG. 11 is a diagram illustrating a third example display screen of the printer driver representing the present disclosure.

### DESCRIPTION OF THE EMBODIMENTS

Hereinafter, embodiments will be described in detail with reference to the attached drawings. The following embodiments do not limit the disclosure according to the claims. A plurality of features is described in the embodiments; however, not every feature is necessarily essential to the disclosure, and the plurality of features may be combined as appropriate. Further, in the attached drawings, the same or similar components are denoted by the same reference numerals, and redundant description is omitted.

Hereinafter, embodiments of the present disclosure will be described with reference to the drawings.

### System Configuration

In an embodiment, a printer driver 214 is stored in an external memory 211 of a host computer, read into a random access memory (RAM) 202, and executed by a central processing unit (CPU) 201.

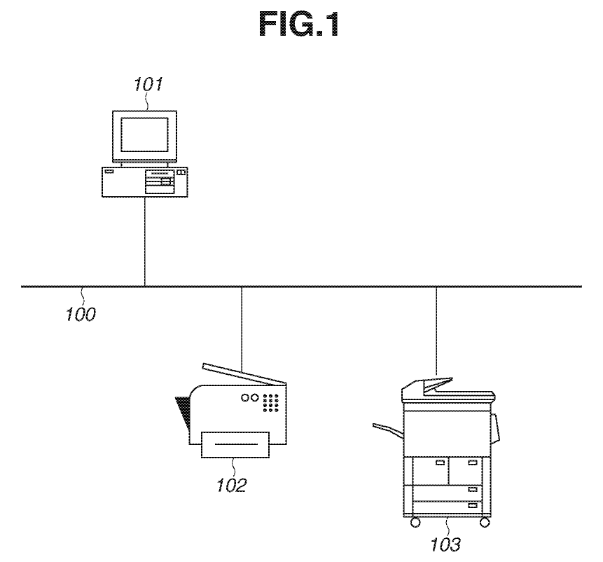

FIG. 1 is an overall diagram of a system according to an embodiment of the present disclosure, in which a host computer 101, which is an example of an information processing apparatus, and printing apparatuses 102 and 103 are connected to a network 100. Hereinafter, a case of printing using the printing apparatus 102 will be described, but the description applies to a case where the printing apparatus 102 is replaced with the printing apparatus 103.

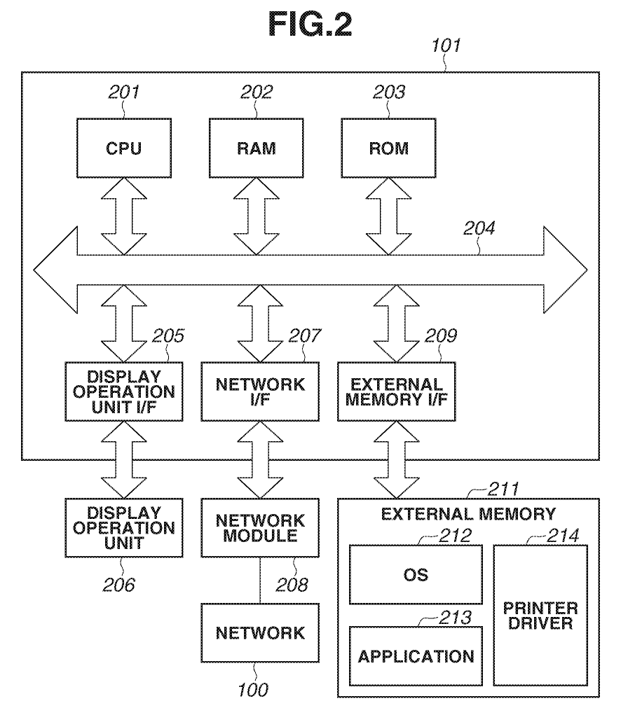

FIG. 2 is a block diagram illustrating an internal configuration of the host computer 101. In the host computer 101, the CPU 201 controls respective devices connected to a system bus 204 based on programs stored in the RAM 202.

The RAM 202 also functions as a main memory and a work area for the CPU 201. A read-only memory (ROM) 203 stores various basic programs and data for the system.

A display operation unit interface (I/F) 205 controls display of information on a display operation unit 206. The display operation unit 206 has a display function, and also functions as a touch panel, thereby controlling input from a user. A network I/F 207 controls a network module 208 to implement network communication. An external memory I/F 209 controls access to the external memory 211 such as a flash memory or a solid state disk.

The external memory 211 stores an operating system program (hereinafter referred to as an OS) 212, various applications 213, and the printer driver 214, and functions as a storage medium into or from which the host computer 101 can store or read the OS 212, the various applications 213, and the printer driver 214.

The RAM 202 and the external memory 211 are examples of a storage unit.

### Printer Driver

The printer driver 214 will now be described. A print job can be generated and output to the printing apparatus 102 by using the printer driver 214.

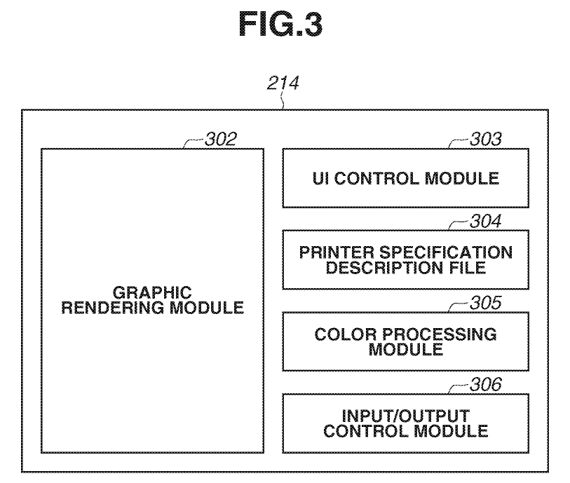

The printer driver 214 includes modules as illustrated in FIG. 3. The printer driver 214 includes a graphic rendering module 302, a UI control module 303, a printer specification description file 304, a color processing module 305, and an input/output control module 306. Depending on the functions of the printer driver 214, the printer driver 214 may include other modules.

In the present embodiment, information regarding capabilities and a configuration of the printing apparatus 102 is acquired by the input/output control module 306, and displayed content of the UI control module 303 is changed.

The printer driver 214 can be configured to perform processing for a single printer, or can be configured to perform processing for a plurality of printers, depending on the configuration of the modules included in the printer driver 214.

For example, in a generic printer driver as the printer driver 214, for one printer driver to support a plurality of printers, the graphic rendering module 302 and the UI control module 303 are created to support the plurality of printers. Printer specification description files 304 for all supported printers are bundled with the generic printer driver.

In such a configuration, the UI control module 303 displays and controls a UI in based on the printer specification description file 304. In addition, the graphic rendering module 302 is configured to generate print data described in a page description language corresponding to each printer, and to issue printer control commands.

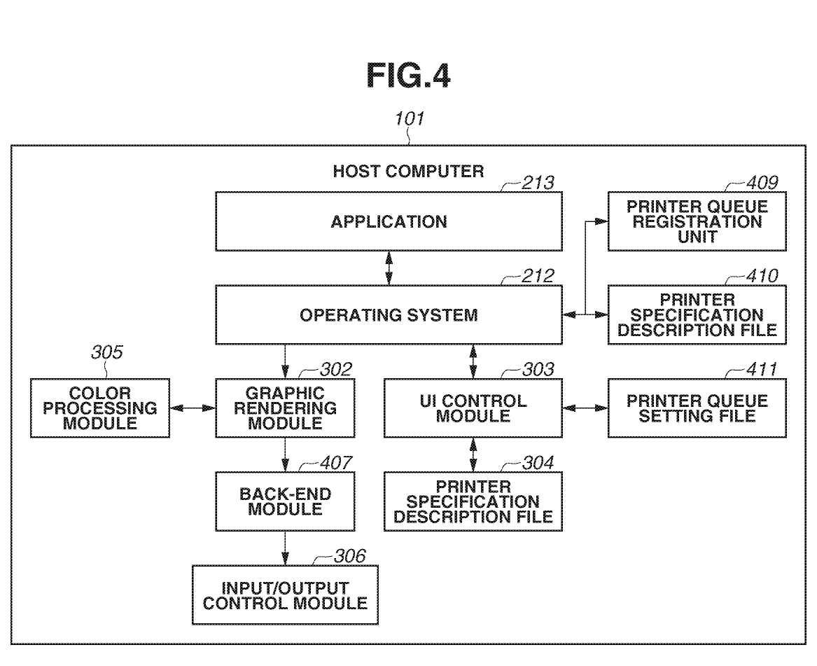

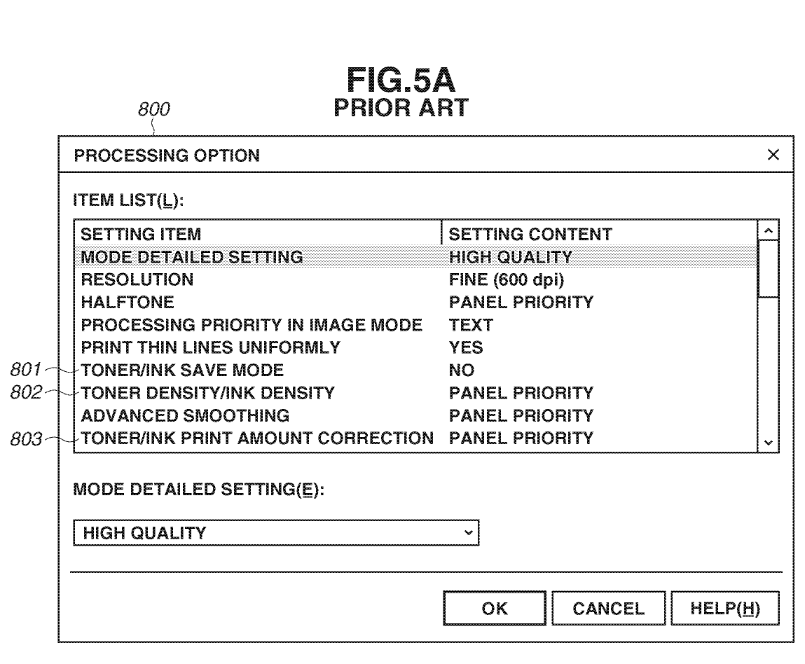

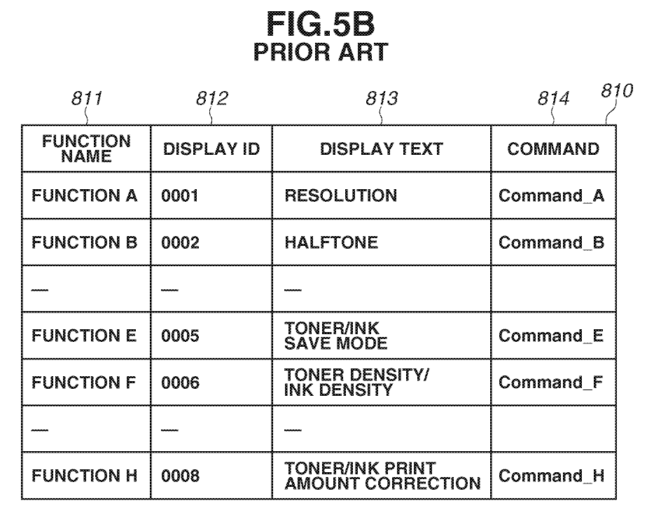

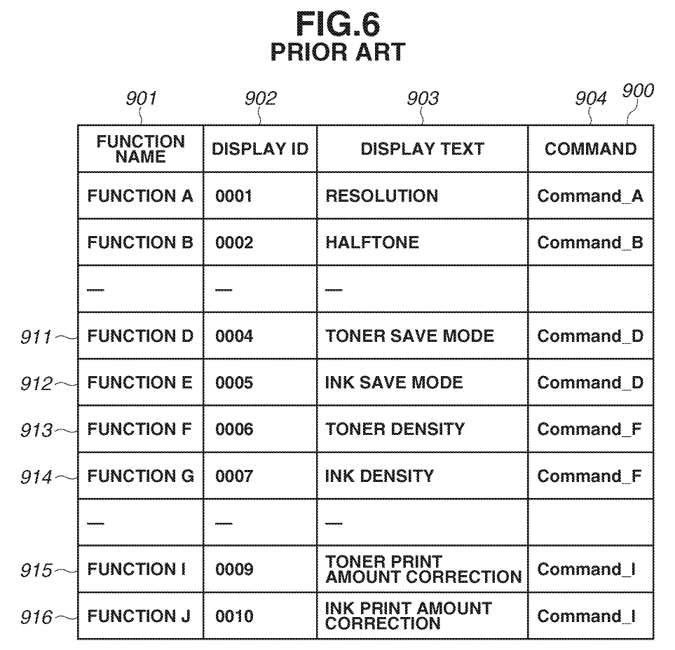

FIG. 4 is a system block diagram illustrating a state in which the printer driver 214 is installed. In FIG. 4, the graphic rendering module 302 is one of the modules of the installed printer driver 214.

A back-end module 407 is provided by the OS 212, and is a module for passing print data generated by the graphic rendering module 302 to the input/output control module 306 for transmitting the print data to a printer. The printer specification description file 304 applies to the printer driver 214 as a whole, and a printer specification description file 410 records current setting values.

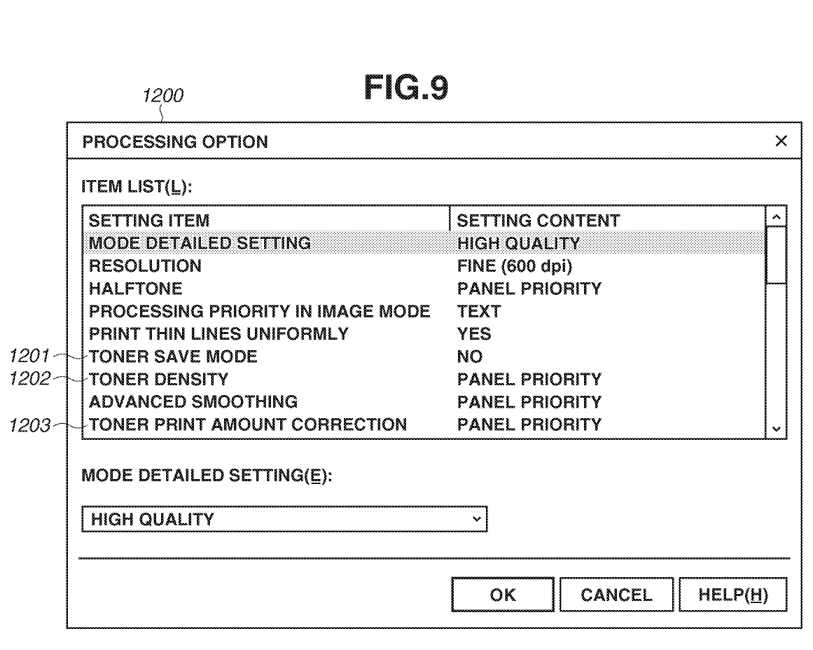

FIGS. 9-11 illustrate examples of display of various printer driver settings in a property screen that can be displayed by a user’s right-clicking or the like on a printer queue installed in the OS 212. The displayed content and the display methods may be different. For example, in the case of Windows® 10, the printer queue corresponds to a printer driver queue displayed in "Devices and Printers" of a control panel. The property screen may be accessed from any screen of the printer driver 214.

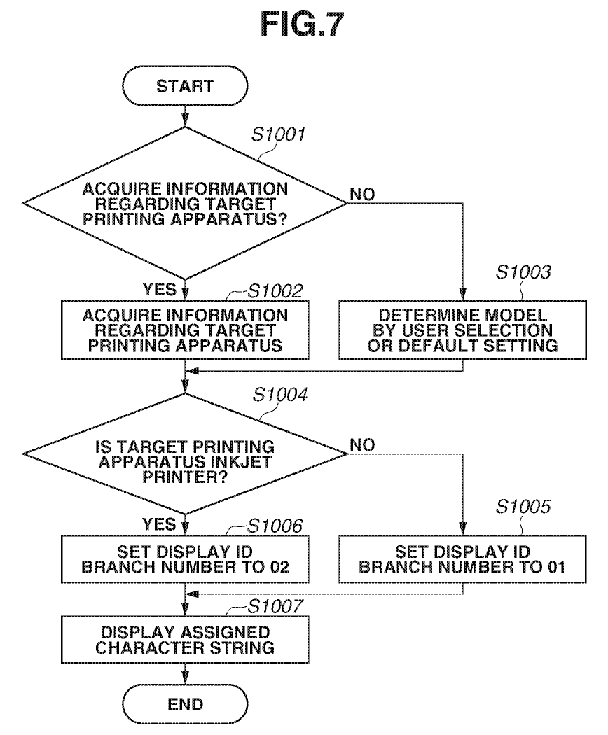

An operation flow of the printer driver 214 is illustrated in FIG. 7. When a display instruction of a property screen of the printer driver 214 is received from a printer queue of the OS 212, the flow illustrated in FIG. 7 is started.

In step S1001, the CPU 201 determines whether to acquire various pieces of configuration information regarding the printing apparatus 102 that is registered as a port destination of the printer driver 214. In the determination, a button operation or the like performed by a user on the printer driver 214 is referred to.

In a case where the various pieces of configuration information regarding the printing apparatus 102 is to be acquired (YES in step S1001), in step S1002, the CPU 201 acquires information regarding a configuration of the printing apparatus 102. The configuration information may be acquired from the printing apparatus 102 by communication, or information stored in the RAM 202 or the external memory of the host computer 101 at the time of installation of the printer driver 214 may be acquired as the configuration information.

In a case where the various pieces of configuration information regarding the printing apparatus 102 is not acquired (NO in step S1001), in step S1003, the CPU 201 identifies a model of the printing apparatus 102 as the port destination based on manual selection by the user.

Next, in step S1004, the CPU 201 determines whether the printing apparatus 102 is an inkjet printer. In a case where the printing apparatus 102 is not an inkjet printer (NO in step S1004), in step S1005, the CPU 201 sets a branch number of a display ID of a character string to be displayed by the printer driver 214 to "01" (details will be described below). In a case where the printing apparatus 102 is an inkjet printer (YES in step S1004), in step S1006, the CPU 201 sets the branch number of the display ID of the character string to be displayed by the printer driver 214 to "02".

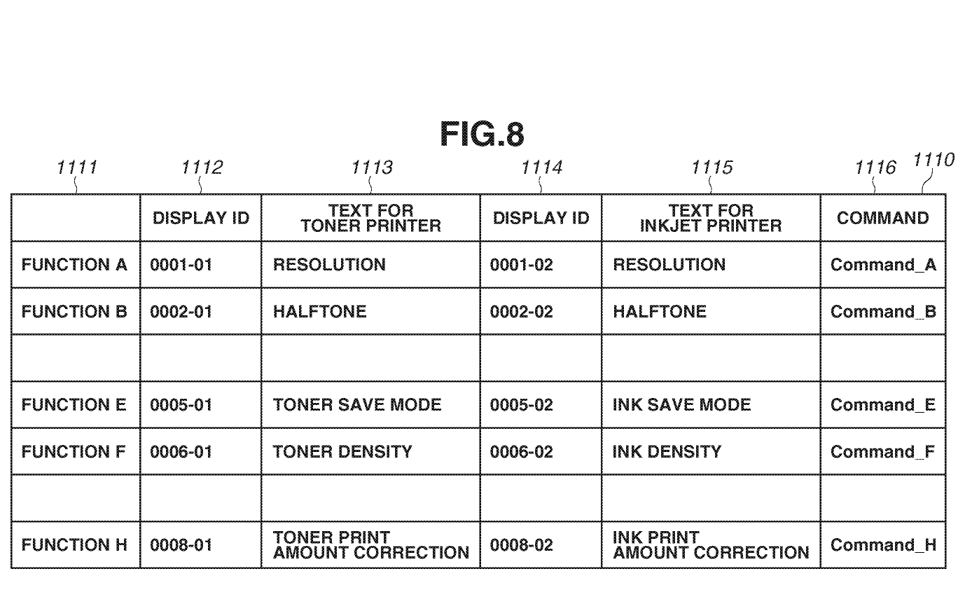

In step S1007, the CPU 201 displays, using the printer driver 214, a character string assigned to the branch number set in step S1005 or step S1006 from a display character string table 1110 illustrated in FIG. 8.

The character string table 1110 illustrated in FIG. 8 includes, for each function 1111 (functions A to H), a display ID 1112, a text for an electrophotographic printer 1113, a text for an inkjet printer 1115, and a command 1116 to be transmitted to the printing apparatus 102.

In the present embodiment, the display ID 1112 includes a four-digit numerical value for identifying a function and a two-digit branch number following a hyphen "-". The branch number "01" indicates an electrophotographic printer, while the branch number "02" indicates an inkjet printer.

A timing at which the character string is displayed is a time point at which a screen of a corresponding function is displayed. Regardless of which branch number is set, it is indicated in the command column 1116 that a command issued for each function does not change. That is, functions having the same purpose but using different color materials (only black may be used) are displayed with different names. Examples include an ink save mode and a toner save mode.

FIG. 9 illustrates an example display screen in a case where the printing apparatus 102 registered as the port destination of the printer driver 214 is an electrophotographic printer in step S1005, and indicates that functions related to "toner" are displayed as items 1201 to 1203.

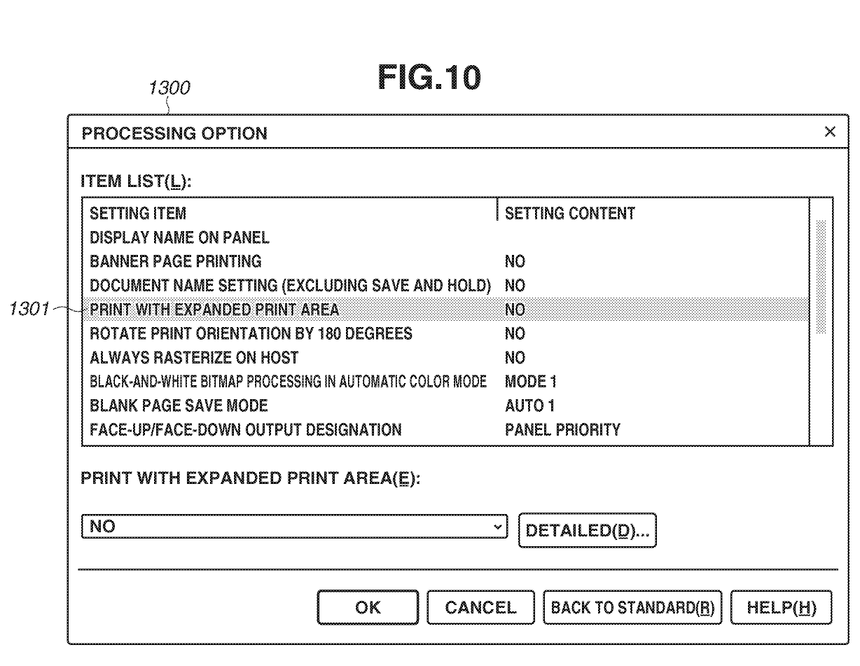

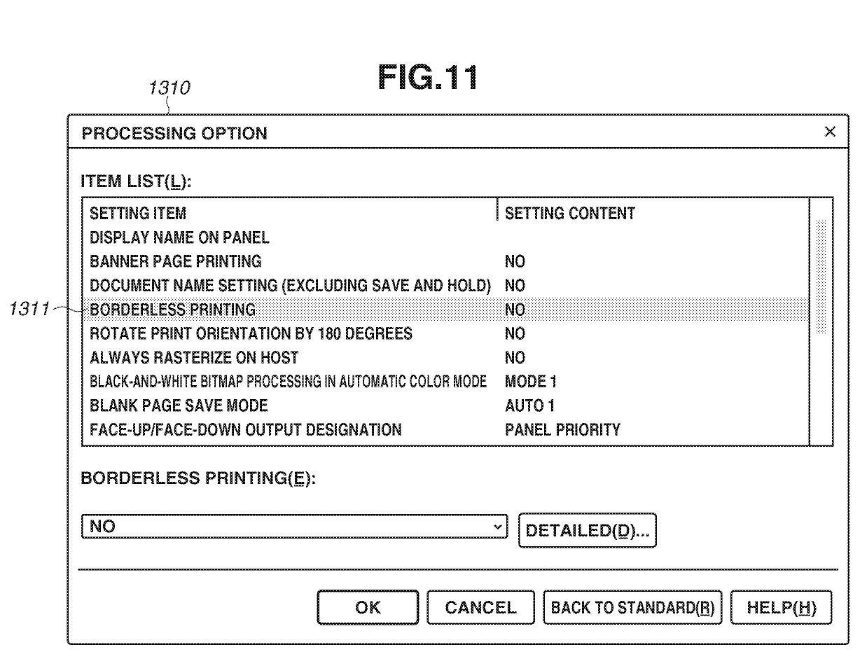

FIG. 10 illustrates an example display screen in a case where the printing apparatus 102 registered as the port destination of the printer driver 214 is an electrophotographic printer in step S1001. In the example illustrated in FIG. 10, a function for printing with reduced margins is displayed as "print with expanded print area" 1301. FIG. 11 illustrates an example display screen in a case where the printing apparatus 102 registered as the port destination of the printer driver 214 is an inkjet printer in step S1001. In the example illustrated in FIG. 11, a function for printing with reduced margins is displayed as "borderless printing" 1311. The display may be changed for other functions as well depending on the type of the printer.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-076161, filed May 1, 2025, which is hereby incorporated by reference herein in its entirety.

What is claimed is:

1. A method for an information processing apparatus, the method comprising:
determining a method for determining a type of a printing apparatus;
acquiring, in a case where it is determined to acquire information indicating the type from the printing apparatus, the information indicating the type from the printing apparatus, and in a case where it is determined to cause a user to select the type, a result of selection of the type by the user; and
displaying, based on the acquired type, functions having a same purpose with different names.

2. The method according to claim 1, wherein the type indicates whether the printing apparatus uses ink or toner.

3. The method according to claim 1, wherein the information indicating the type is stored in the information processing apparatus when a printer driver for generating a print job to be transmitted to the printing apparatus is installed in the information processing apparatus.

4. The method according to claim 1, wherein,
in a case where the type indicates an inkjet printing apparatus, a text indicating borderless printing is displayed, and
in a case where the type indicates an electrophotographic printing apparatus, a text indicating printing with an expanded print area is displayed.

5. The method according to claim 1, wherein,
in a case where the type indicates an inkjet printing apparatus, a text indicating an ink save mode is displayed, and
in a case where the type indicates an electrophotographic printing apparatus, a text indicating a toner save mode is displayed.

6. An information processing apparatus comprising:
a memory storing at least one program; and
at least one processor, that when executing the at least one program, causes the information processing apparatus to:
determine a method for determining a type of a printing apparatus;
acquire, in a case where it is determined to acquire information indicating the type from the printing apparatus, the information indicating the type from the printing apparatus, and in a case where it is determined to cause a user to select the type, a result of selection of the type by the user; and
display, based on the acquired type, functions having a same purpose with different names.
